(19) United States
(12) Patent Application Publication
(10) Pub. No.: US 2009/0058621 A1
(43) Pub. Date: Mar. 5, 2009

(54) Multifunction crash-protecting alerting system

(76) Inventor: San-Lin Yen, Taipei (TW)

Correspondence Address: BACON & THOMAS, PLLC, 625 SLATERS LANE, FOURTH FLOOR, ALEXANDRIA, VA, 22314-1176, US

(21) Appl. No.: 11/896,659

(22) Filed: Sep. 5, 2007

(51) Int. Cl. B60Q 1/00

(52) U.S. Cl. 340/435

(57) ABSTRACT

A multifunction crash-protecting alerting system to one embodiment of the present invention mainly comprises a host capable of configuring in a carrier, a micro processor arranged in the host, wherein the micro processor has control programs controlling detecting, altering and lighting functions. The micro processor is coupled respectively with a speaker, an accelerator system of a vehicle and a brake system. In addition, a panel of the host is configured with at least one indicating light, the indicating lights are coupled with the micro processor and arranged in a plurality of positions surrounding the vehicle. The multifunction crash-protecting alerting system could be used on carriers including aircrafts, ships or any fixed or moving object.

### TECHNICAL FIELD

The present invention relates to a multi-function crash-protecting alerting system, and more particularly, to a multifunction crash-protecting alerting system capable of performing transmitting and receiving functions to implement a purpose for crash-protecting alerting by warning a carrier and compel the carrier to decelerate and stop.

### BACKGROUND ART

While conventional carriers, such as vehicles, aircrafts and ships, are driven, drivers not only have to confirm directions but also have to pay attentions on accidents occurring during movement. In the case of vehicles, a certain distance must be maintained between two vehicles to avoid accidents occurred due to have no time for braking. Moreover, cars approaching from back may also cause accidents when those close our vehicle too much. Excepting determinations made by drivers, all kinds of conventional vehicles could not response at the first time, but also have no abilities to warn the drivers properly or stop said vehicles directly. Therefore, avoidable accidents may happen so as to cause unnecessary losses correspondingly. Hence, applicant develops a multifunction crash-protecting alerting system with hard diligence which could warn the carriers and force the carriers to decelerate or stop when subjects are approaching so as to avoid accidents.

### SUMMARY OF THE INVENTION

In accordance with one aspect of the invention, a multifunction crash-protecting alerting system is provided. The multifunction crash-protecting alerting system is capable of performing transmitting and receiving functions to implement a purpose for crash-protecting alerting by warning a carrier and forcing the carrier to decelerate and stop.

The multifunction crash-protecting alerting system comprises a host and at least one sensors. The host further comprises a micro processor, a speaker and a panel, wherein the panel is configured with at least one indicating lights coupled with the micro processor. The quantities of the sensors, installed in a plurality of position surrounding a vehicle, are similar with the lights and are coupled with the host. The sensors detect whether objects approaching a predefined area and generate a first degree operation performed by the indicating lights and altering-voices and a second degree operation which comprises an accelerator-nullified step and a compelling brake step to implement a purpose for crash-protecting alerting.

The sensors coupled with the host are selected from a combination of super sonic detecting elements, infrared detecting elements, microwave detecting elements and any other detecting element could execute transmitting and feedback receiving functions. The altering-voices generated in the first degree operation are capable of making different altering-voice gradations according to the distance of the approaching object to improve warning effect. The carriers mentioned before comprise aircrafts, ships and any other moving or fixed object.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 illustrates an isometric view of a multifunction crash-protecting alerting system according to one embodiment of the present invention.

FIG. 2 illustrates an isometric view of a multifunction crash-protecting alerting system configured in a vehicle according to one embodiment of the present invention.

FIG. 3 illustrates a circuit diagram according to one embodiment of the present invention.

FIG. 4 illustrates a practice diagram according to one embodiment of the present invention.

FIG. 5 illustrates a processing flowchart of a multifunction crash-protecting alerting system according to one embodiment of the present invention.

FIG. 6 illustrates an isometric view of a multifunction crash-protecting alerting system according to second embodiment of the present invention.

### DESCRIPTION OF THE EMBODIMENT

Reference will now be made in detail to the embodiments of the present invention, fastener. While the invention will be described in conjunction with the embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, and components have not been described in detail as not to unnecessarily obscure aspects of the present invention.

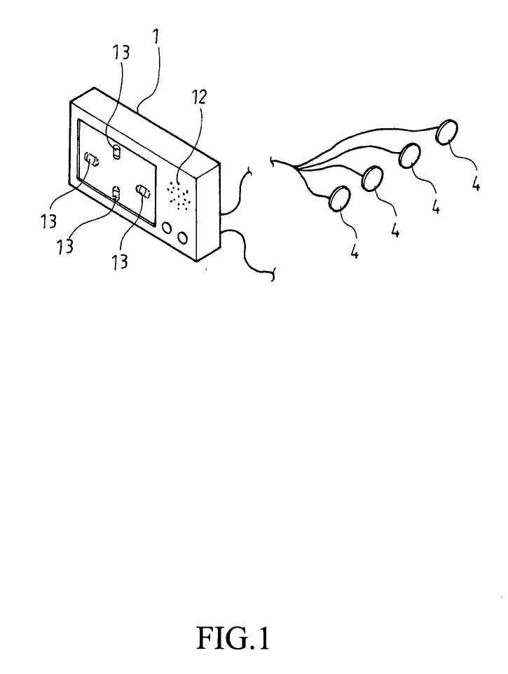

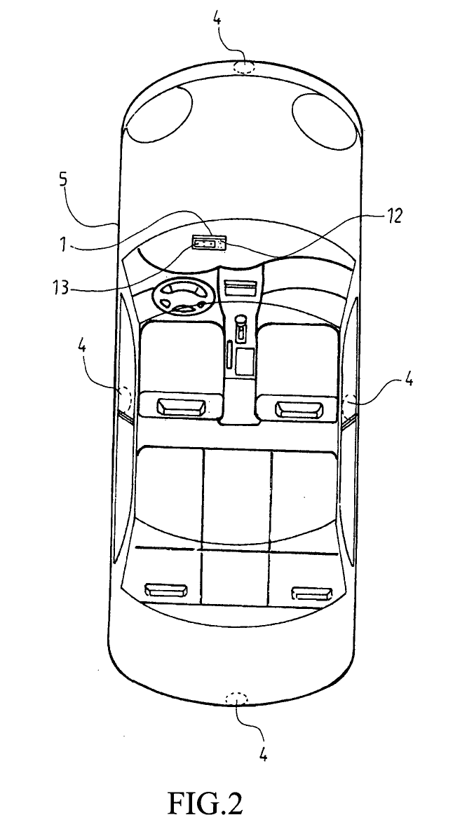

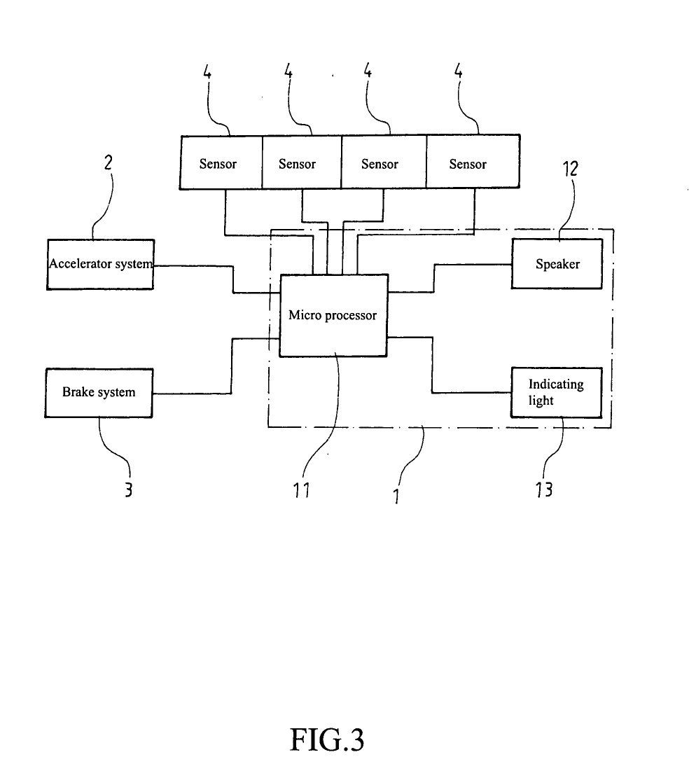

Please referring to FIG. 1, FIG. 2 and FIG. 3, a multifunction crash-protecting alerting system to one embodiment of the present invention mainly comprises a host 1 capable of configuring in a carrier, a micro processor 11 arranged in the host 1, wherein the micro processor 11 has control programs which control detecting processes, altering and lighting functions. The micro processor 11 is coupled respectively with a speaker 12, an accelerator system 2 of a vehicle 5 and a brake system 3. In addition, a panel of the host 1 is configured with at least one indicating light 13, the indicating lights 13 are coupled with the micro processor 11 and arranged in a plurality of positions surrounding the vehicle.

At least one sensor 4 are coupled with the micro processor 11 of the host 1, which are selected from a combination of super sonic detecting elements, infrared detecting elements, microwave detecting elements and any other detecting element could execute transmitting and feedback receiving functions.

Through the combination of above mentioned elements, the host is configured in a driving seat of the vehicle 5 or other positions that provide clean eyeshot for drivers. The sensors is respectively configured in the positions surrounding the vehicle, including a position in front of the vehicle 5, a position back of the vehicle 5 and positions surrounding the vehicle 5 so as to constitute a single-way detection and an omni bearing detection for detecting any subject approaching in a predefined area by transmitting and feedback receiving functions execute by the sensors 4. For instance, the approaching objects could approach to the vehicle 5 passively and actively according to the distance and the velocity relative to the vehicle 5, and the predefined area is configured by the programs accessed by the micro processor to set a safety configuration. For implementing the purpose of the multifunction crash-protecting alerting system, a first degree operation, consisting of altering-voices made by the indicating lights 13 and the speaker 12, are conducted to notify drivers and cut the accelerator system 2 off for reducing speed of the vehicle, then a second degree step is performed to brake the vehicle by the brake system 3.

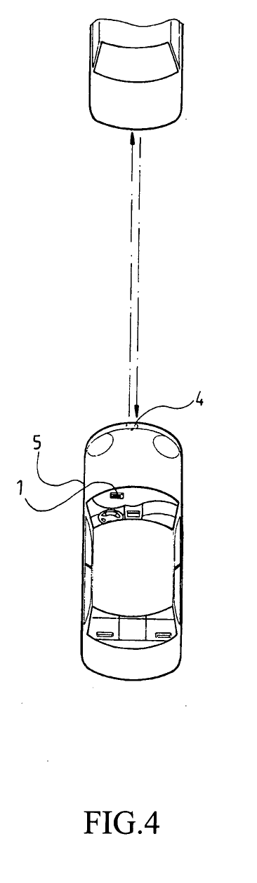

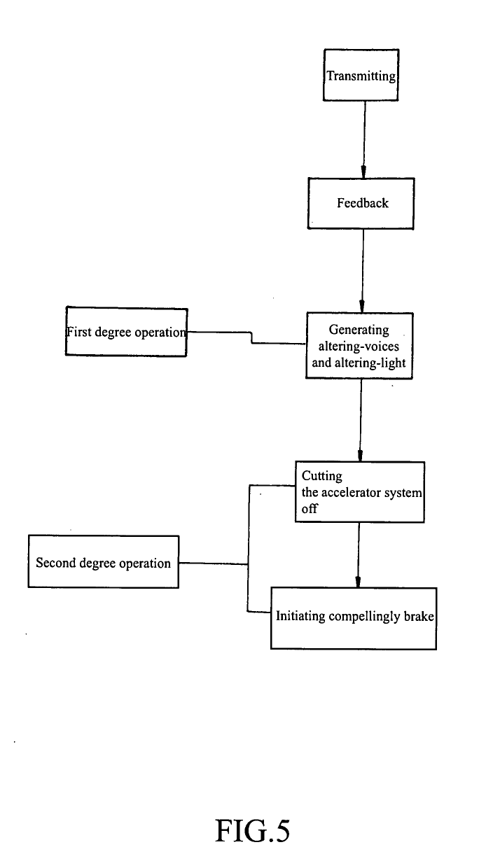

Please referring to FIG. 4, FIG. 5 and FIG. 1, according to one embodiment of the present invention. When the vehicle 5 closes a vehicle 6 in front of it too much during driving so that the vehicle 6 approaches into the predefined area, the host 1 determines this situation and generates above mentioned crash-protecting altering operations by executing transmitting and feedback receiving functions for detecting the vehicle 6 approaching into the predefined area. Said crash-protecting altering operations comprise below steps:

1. While the vehicle 6 in front of the vehicle 5 approaches into the predefined area, a first degree operation is performed. In a first degree operation, the lights configured in the same position with the host 1 are ignited intermittently to notify drivers to pay attention on the traffic circumstance forward, the speaker 12 is driven to generate altering-voices and the audio system is turned off. The altering-voices generated in the first degree operation is capable of making different altering-voice gradations according to the distance of the approaching object, such as long interval with longer distance and shot interval with shorter distances, to notify drivers to decelerate or stop the vehicle 5.

2. If speed of the vehicle still doesn't been reduced after the first degree operation, a second degree operation is performed. In the second degree operation, the host 1 cuts the accelerator system 2 off to decelerate the vehicle 5 (it means, the gas pedal is invalidated even when drivers tread the gas pedal.) and initiates compellingly brake by the brake system 3 to implement the purpose of the crash-protecting alerting system.

3. If the vehicle 5 is static and approached by a car in front, the host 1 notifies the owner by radio remote means. It could also be used on other fixed objects.

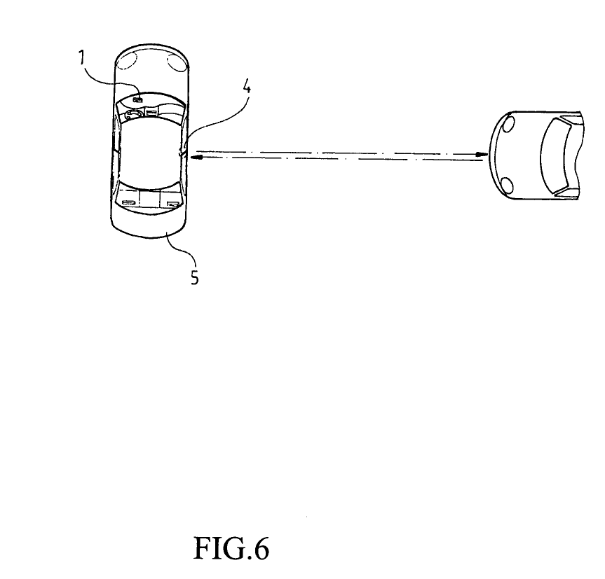

Please referring to FIG. 6 and FIG. 1, while a vehicle 7 aside of the vehicle 5 approaches into the predefined area, since it's not urgent enough to initiates brake compellingly or decelerate, the host 1 only ignited the indicating lights 13 intermittently to notify drivers to pay attention on the traffic circumstance aside. At the same time, the speaker 12 generates altering-voices different from the altering-voices generated when vehicles approached in front. Therefore, drivers be notified opportunely.

In conclusion, The present invention relates to a multi-function crash-protecting alerting system capable of transmitting and receiving a feedback signal to implement a purpose for crash-protecting alerting by warning a carrier and forcing the carrier to decelerate and stop. Foregoing descriptions and drawings represent the preferred embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A multifunction crash-protecting alerting system, comprises:
at least one sensors configured in a plurality of position surrounding a carrier to implement one-way detecting and omni bearing for detecting objects approaching into a predefined area by transmitting and feedback signal receiving functions of the sensors; and
a host, coupled with the sensors, generating altering-voices and altering-light to notify drivers and decelerating and stopping the carrier compellingly.

2. As cited in claim 1, wherein the sensors coupled with the host are selected from a combination of super sonic detecting elements, infrared detecting elements, and microwave detecting elements.

3. As cited in claim 1, wherein the altering-voices capable of making different gradations according to the distance of the approaching object to notify drivers to decelerate or stop.

4. As cited in claim 1, wherein the host, used on a vehicle, coupled with an accelerator system and a brake system respectively, capable of cutting the accelerator system off and initiates compellingly brake by the brake system to decelerate and stop the vehicle when drivers have no response after the altering-voices.
